(19) United States
(12) Patent Application Publication
(10) Pub. No.: US 2023/0380023 A1
(43) Pub. Date: Nov. 23, 2023

(54) SYSTEMS AND METHODS FOR INDUCTION HEATING

(71) Applicant: Hatco Corporation, Milwaukee, WI (US)

(72) Inventors: Nicholas Bassill, Milwaukee, WI (US); Fei Shang, Milwaukee, WI (US); Mark Gilpatric, Milwaukee, WI (US); Greg Sterr, Milwaukee, WI (US); James Jakubowski, Milwaukee, WI (US); Edward Nunn, Milwaukee, WI (US); Ming Liu, Milwaukee, WI (US)

(21) Appl. No.: 18/319,286

(22) Filed: May 17, 2023

Related U.S. Application Data
(60) Provisional application No. 63/343,865, filed on May 19, 2022.

(51) Int. Cl. H05B 6/06; H05B 6/44

(52) U.S. Cl. CPC H05B 6/065; H05B 6/44

(57) ABSTRACT

Systems, methods, and media for induction heating a first food vessel of a first size and a second food vessel of a second size include a base defining a well to separately receive the first food vessel and the second food vessel. A plurality of coil assemblies are mounted to a bottom side of a tray. The plurality of induction coils are electrically coupled with an inverter of the induction heating system. A sensing system is configured to indirectly measure a temperature of the first food vessel when the first food vessel is resting in the well and the second food vessel when the second food vessel is resting in the well. A controller is communicatively coupled with the sensing system and the inverter and is configured receive the temperature measurement from the sensing system, and control the inverter according to the measurement.

### CROSS-REFERENCE TO RELATED APPLICATIONS

The present application claims priority to U.S. Provisional Patent Application No. 63/343,865 filed May 19, 2022, the entire contents of which are hereby incorporated by reference.

### BACKGROUND

The use of hot chaffing pans to keep food warm on buffet lines is popular in restaurants and hotels to present the food to customers. Food pans come in various sizes (including various lengths, widths, and/or depths), and may sit in a well having a heating source. Existing induction warming solutions for a food well are designed for a fixed pan size, and heating of the pan is concentrated in a small area near the center of the pan where the heating source is located and does not extend to the pan perimeter. Further, when a pan smaller than the well size (e.g., a third-size pan) is placed in the well, the heating source can heat the edges (e.g., the rim) of the pan to a very high temperature and, for an induction-type heating element, can cause arcing. In addition, when the heating source includes induction coils connected in series, the resulting magnetic field is enhanced or reduced according to the direction of current flow due to interferences between the edges of the coils, which can lead to unevenly distributed heat patterns in the pan.

Accordingly, improved systems, methods, and media for improved induction heating of food pans are desirable.

### SUMMARY

In accordance with some embodiments of the disclosed subject matter, systems, methods, and media for induction heating are provided.

According to some aspects of the present disclosure, an induction heating system for a first food vessel of a first size and a second food vessel of a second size is provided. The system can include a base defining a well configured to separately receive the first food vessel and the second food vessel; a tray configured to attach within the well; a plurality of coil assemblies mounted to a bottom side of the tray, wherein each coil assembly comprises a plurality of induction coils electrically coupled in series, wherein for each coil assembly, each of the plurality of induction coils defines an oblong shape having a length and a width; each of the plurality of induction coils is arranged adjacent to at least one other of the plurality of induction coils along a longest side of the induction coil; and the plurality of induction coils are electrically coupled with an inverter of the induction heating system; a sensing system configured to indirectly measure a temperature of the first food vessel when the first food vessel is resting in the well and the second food vessel when the second food vessel is resting in the well; and a controller communicatively coupled with the sensing system and the inverter, wherein the controller is configured to receive the temperature measurement from the sensing system; and control the inverter according to the measurement.

In some aspects, each of the plurality of coil assemblies comprise a ferrite arrangement arranged about the plurality of induction coils, wherein the ferrite arrangement has an increased density proximate to where two of the plurality of induction coils are adjacent and a decreased density at an outer side of the coil assembly.

In some aspects, the system further comprises two coil assemblies, wherein each coil assembly comprises three induction coils.

In some aspects, each of the plurality of coil assemblies is electrically coupled with a separate inverter.

In some aspects, the tray is a moveable tray configured to attach within the well, wherein the well is configured to attach with the moveable tray at a first tray depth and at a second tray depth, and wherein the first tray depth is in accordance with a first food vessel depth and the second tray depth is in accordance with a second food vessel depth, wherein the first food vessel depth is different than the second food vessel depth.

In some aspects, when the moveable tray is attached at the first tray depth, the distance between a top surface of the well and a top side of the moveable tray is less than the first food vessel depth; and when the moveable tray is attached at the second tray depth, the distance between the top surface of the well and the top side of the moveable tray is less than the second food vessel depth.

In some aspects, when the moveable tray is attached at the first tray depth and the first food vessel is resting in the well, the rim of the first food vessel is spaced apart from the top surface of the well; and when the moveable tray is attached at the second tray depth and the second food vessel is resting in the well, the rim of the second food vessel is spaced apart from the top surface of the well.

In some aspects, the sensing system comprises a plurality of thermal sensors arranged about each of the plurality of coil assemblies; the temperature measurement comprises a plurality of temperature measurements, one from each of the plurality of thermal sensors; and the controller is configured to determine a location of the first food vessel or the second food vessel based on the plurality of temperature measurements; and select, from the plurality of coil assemblies, the one or more coil assemblies located directly below the determined location of the first food vessel or the second food vessel; and control the inverter electrically coupled with each of the one or more selected coil assemblies to provide power to the plurality of induction coils of the selected coil assembly.

In some aspects, the plurality of thermal sensors comprise a plurality of thermistors coupled to the bottom side of the moveable tray.

In some aspects, the controller is configured to receive a temperature setting; and control the inverter electrically coupled with each of the one or more selected coil assemblies to provide power to the plurality of induction coils of the selected coil assembly according to the temperature setting and the plurality of temperature measurements.

In some aspects, the tray comprises a non-ferrous material.

According to some aspects of the present disclosure, a method for heating a changeable food vessel resting in a food well, wherein the changeable food vessel can be a first food vessel of a first size or a second food vessel of a second size, and wherein a plurality of coil assemblies each having a plurality of induction coils are attached to the bottom side of the food well is provided.

The method can include determining, by a controller, a location and a size of the changeable food vessel in the well; selecting, by the controller, one or more of the plurality of coil assemblies to heat the changeable food vessel; receiving, by the controller and from a plurality of thermal sensors coupled to the food well, a plurality of temperature measurements; receiving, by the controller, a temperature setpoint for the changeable food vessel; and controlling, by the controller, a power to the selected coil assemblies according to the received temperature measurements and the received temperature setpoint.

In some aspects, each coil assembly comprises an inverter electrically coupled to the induction coils, and wherein controlling the power to the selected coil assembly comprises controlling the inverter of the selected coil assembly.

In some aspects, the one or more coil assemblies are selected according to the determined location and the determined size of the changeable food vessel.

In some aspects, selecting the one or more coil assemblies comprises selecting only the coil assemblies from the plurality of coil assemblies that are located directly below the changeable food vessel.

In some aspects, determining the location and the size of the changeable food vessel comprises determining the location and the size of the changeable food vessel based on the received plurality of temperature measurements.

In some aspects, determining the location and the size based on the received plurality of temperature measurements comprises determining the location and the size of the changeable food vessel according to a location of the one or more thermal sensors from which a temperature measurement above a predetermined threshold was received.

In some aspects, determining the location and the size of the changeable food vessel comprises determining a location of the one or more thermal sensors from which a temperature measurement above a predetermined threshold was received; and selecting the one or more coil assemblies comprises selecting only the coil assemblies from the plurality of coil assemblies that are directly below the changeable food vessel based on the determined location and size of the changeable food vessel.

According to some aspects of the present disclosure, an induction heating system for a changeable food vessel, wherein the changeable food vessel can be a first food vessel of a first predetermined width or a second food vessel of a second predetermined width, wherein the second width is larger than the first width and wherein the second width is less than full-width, is provided.

The system can include a well configured to separately receive the first food vessel and the second food vessel; a plurality of induction coils mounted to a bottom side of the well, wherein a perimeter of a first set of the plurality of induction coils, located directly below a first well location where the well is configured to receive the first food vessel, does not overlap the rim of the first food vessel; and a perimeter of a second set of the plurality of induction coils, the second set comprising the first set and located directly below a second well location where the well is configured to receive the second food vessel, does not overlap the rim of the second food vessel; a plurality of thermal sensors arranged about the well, wherein the thermal sensor arrangement is configured to indirectly measure a temperature of the changeable food vessel; and a controller communicatively coupled with the plurality of thermal sensors and the plurality of induction coils, wherein the controller is configured to receive a plurality of temperature measurements from the plurality of thermal sensors; determine the well location and the width of the changeable food vessel; select one of the first set of induction coils or the second set of induction coils based on the determined well location and width; and control power to the selected set of induction coils according to the plurality of temperature measurements and the received temperature setting.

In some aspects, the well location and width of the changeable food vessel is determined according to the received temp measurements.

In some aspects, the width of each of the plurality of coils is at or less than 3.5 inches and each of the plurality of coils has 20 or less turns.

### BRIEF DESCRIPTION OF THE DRAWINGS

The present disclosure will hereafter be described with reference to the accompanying drawings, wherein like reference numerals denote like elements.

FIG. 1 is an exploded view of an exemplary induction heating system, in accordance with an embodiment.

FIG. 2A illustrates a tray in a first position in the induction heating system, in accordance with an embodiment.

FIG. 2B illustrates a tray in a second position in the induction heating system, in accordance with an embodiment.

FIG. 3A illustrates a first arrangement of third-size food vessels resting in the induction heating system, in accordance with an embodiment.

FIG. 3B illustrates a second arrangement of third-size food vessels resting in the induction heating system, in accordance with an embodiment.

FIG. 3C illustrates a full-size food vessel resting in the induction heating system, in accordance with an embodiment.

FIG. 4A is a cross-section view of an exemplary induction heating system, in accordance with an embodiment.

FIG. 4B is a cross-section view of an exemplary induction heating system as viewed from below, in accordance with an embodiment.

FIG. 5A is an exploded view of an induction coil assembly, in accordance with an embodiment.

FIG. 5B illustrates an induction coil assembly, in accordance with an embodiment.

FIG. 5C is a cut-out view of an induction coil having asymmetric ferrite arrangements, in accordance with an embodiment.

FIG. 5D illustrates the thermal profile of an unevenly heated vessel.

FIG. 5E illustrates the thermal profile of a vessel heated according to the ferrite arrangement of FIG. 5C, in accordance with an embodiment.

FIG. 6A representatively illustrates a cross-section of a full-size food pan resting in a well of an induction heating system, in accordance with an embodiment.

FIG. 6B representatively illustrates a cross-section of a full-size food pan resting in a well of an induction heating system and a refrigeration system, in accordance with an embodiment.

FIG. 7 illustrates an exemplary method for induction heating, in accordance with an embodiment.

FIG. 8 illustrates an exemplary arrangement of thermal sensors in coil assemblies, in accordance with an embodiment.

### DETAILED DESCRIPTION

It should be understood that the present disclosure is not limited strictly to the details or methodology set forth in the description or illustrated in the figures. It should also be understood that the terminology is for the purpose of description only and should not be regarded as limiting.

In accordance with some embodiments of the disclosed subject matter, systems, methods, and media for induction heating are provided. In particular, novel induction heating and sensing systems and methods are introduced to solve food vessel (e.g., food pan) heating challenges, and which can accommodate various sizes of food vessels. Advantageously, systems and methods according to various embodiments of the present disclosure may provide a more even heating of a food vessel without heating a high edge (i.e., rim) of the food vessel, and without being limited to a single vessel size per food well.

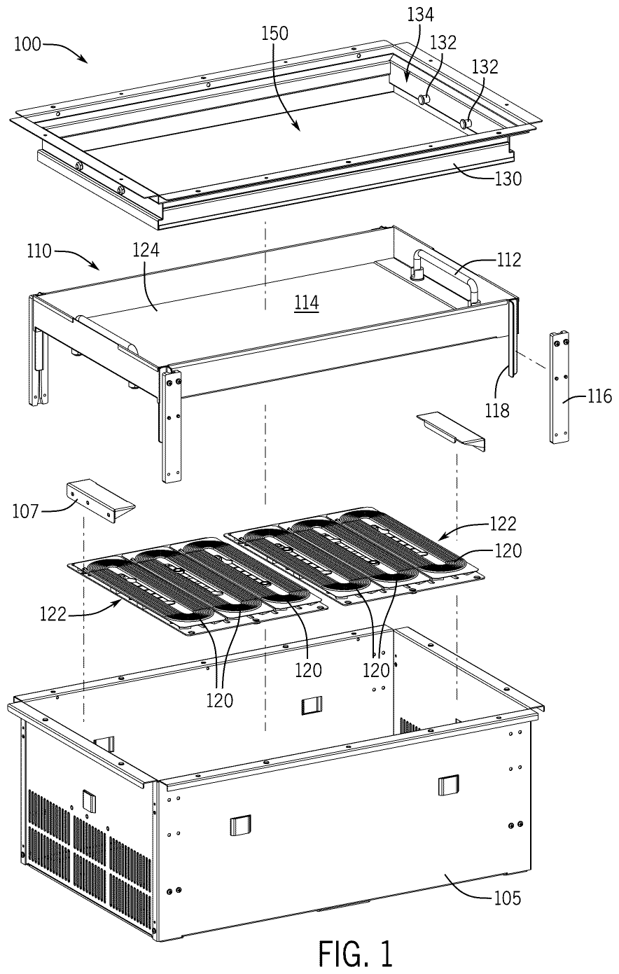

Referring to FIG. 1, an induction heating system 100 according to various aspects of the present disclosure may comprise a base 105 having an open interior, onto which an upper frame 130 may be mounted and into which a tray 110 may be inserted. The upper frame 130 may have an open interior into which a food vessel (not shown) may be inserted, the food vessel resting on (e.g., sitting in contact with) a top surface (also referred to herein as a “top side”) 114 of a separator 124 of the tray 110. Thus the base 105, for example along with the upper frame 130 and tray 110, may define a well 150 into which the food vessel may be placed. The separator 124 may separate the food vessel from one or more heating elements of the induction heating system 100. In some embodiments, the one or more heating elements comprise one or more induction coils 120. The induction coils 120 may provide heating to a food vessel in proximity (e.g., above) the induction coils 120 by inducing eddy currents into the food vessel.

The base 105 may comprise any suitable apparatus to contain suitable electrical components (described in more detail below) and to support the tray 110. In some embodiments the base 105 may be configured to receive an upper frame 130. In some embodiments, the base 105 may comprise a rectangular metallic shell with its upper surface open to receive the tray 110. In some embodiments, the base 105 may comprise leg supports 116 configured to couple with legs 118 of the tray 110. The leg supports 116 may be fixed to the base 105, the legs 118 may be fixed to the tray 110, and the leg supports 116 may slidably support the legs 118. In some embodiments, the legs 118 and leg supports 116 may be configured to allow the legs 118 to slide along the leg supports 116 or otherwise be repositioned with respect to the leg supports 116. For example, in some embodiments the tray 110 may be placed at multiple depths within the base 105 and thus defining a well 150 of multiple depths.

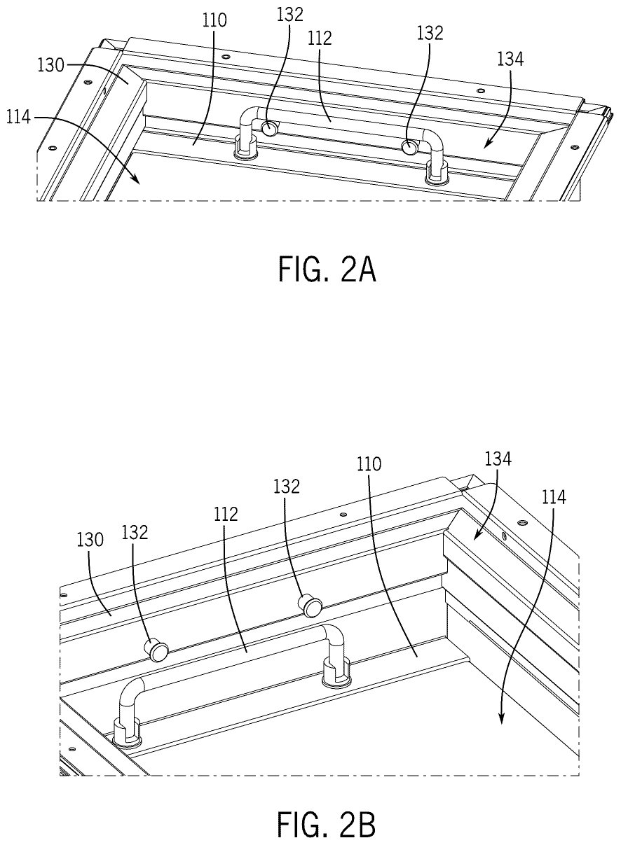

The tray 110 may be a moveable tray configured to attach at different depths within the well 150. Referring now also to FIGS. 2A and 2B, in some embodiments the moveable tray 110 may comprise one or more handles 112 to allow manual positioning of the tray 110 at different depths within the well 150, for example to accommodate food vessels of different depths. In some embodiments, the frame 130 may comprise one or more mounting fixtures 132 configured to removably secure the one or more handles 112. The mounting fixtures 132 may comprise any suitable system or method for supporting or otherwise securing the one or more handles 112. The mounting fixtures 132 may comprise buttons, posts, tabs, hooks, or the like, that can support the handles 112.

The mounting fixtures 132 may comprise tabs to hold the tray 110, by the handles 112, at a first elevated position such as shown in FIG. 2A. For example, the first elevated position may be configured such that the top side 114 of the separator 124 is at a depth to support a food vessel having a depth of 2.5 inches. The handles 112 may be disengaged (if initially engaged) from the mounting fixtures 132 and the tray 110 manually lowered to a second lowered position such as shown in FIG. 2B. For example, the second lowered position may be configured such that the top side 114 of the separator 124 is at a depth to support a food vessel having a depth of 4 inches or 6 inches. In some embodiments, the tray 110 may be resting within the base 105 at the lowered position, supported by the legs 118 and/or leg supports 116, and/or resting on a tray stop 107 of the base 105. The depth of the well 150 (e.g., between separator 124 and the top surface 134 of the well) at each position of the tray 110 may be greater than or equal to the depth of a respective food vessel, such that a rim of the food vessel is at or above the top surface 134 of the well. Accordingly, the tray 110 may be supportable at several heights within the base 105 to accommodate food vessels of various depths.

The top surface 134 of the well 150 may comprise an upward-facing surface at the top of the opening that defines the well 150. In some embodiments, for example as shown in FIGS. 1, 2A, and 2B, an upward-facing surface (but not necessarily the highest surface) of the upper frame 130 may form the top surface 134 of the well 150. In some embodiments, a top surface of the base 105 or a top surface of the tray 110 may form the top surface of the well 150.

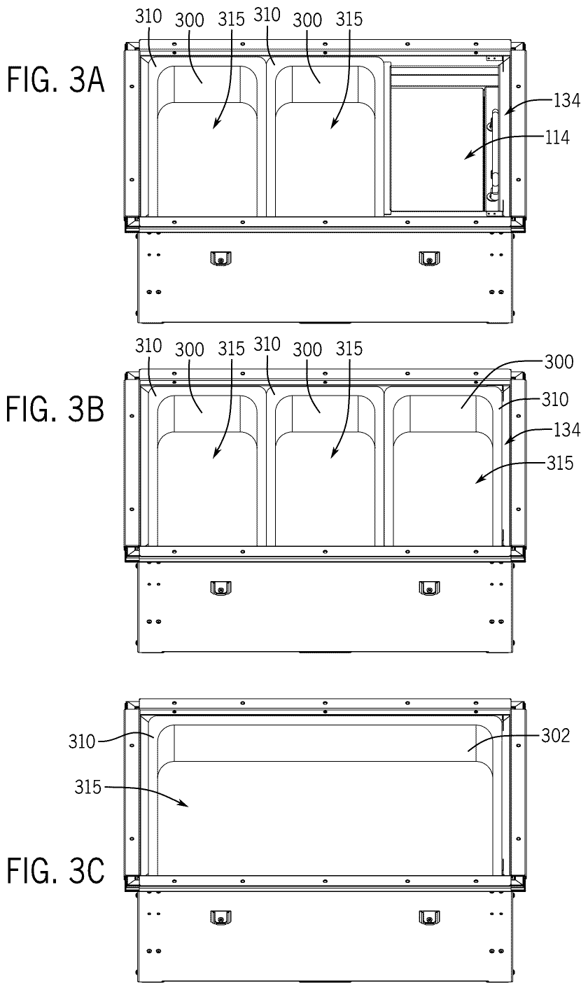

The induction heating system 100 may be configured to accept food vessels of a variety of sizes. Such food vessels may be referred to herein as changeable food vessels, as they may be changed out for other food vessels (possibly of different size) as required. In some embodiments, changeable food vessels may vary in width, length, and/or depth. Referring to FIGS. 3A and 3B, a first food vessel 300 may comprise a third-size food pan, having a width (measured left-to-right with respect to FIG. 3A) that allows three third-size food pans 300 to be placed in the food well 150. For further example, the first food vessel 300 may have a 4-inch depth and the tray 110 may be placed in the second lowered position. Referring to FIG. 3C, a second food vessel 302 may comprise a full-size food pan, having a width (measured left-to-right with respect to FIG. 3C) that takes up the entire width of the food well 150. For further example, the second food vessel 302 may have a 2.5-inch depth and the tray 110 may be placed in the first elevated position. Changeable food vessels can be various other sizes, for example a half-size food pan (not shown) having a width that allows two half-size food pans to be placed in the food well 150.

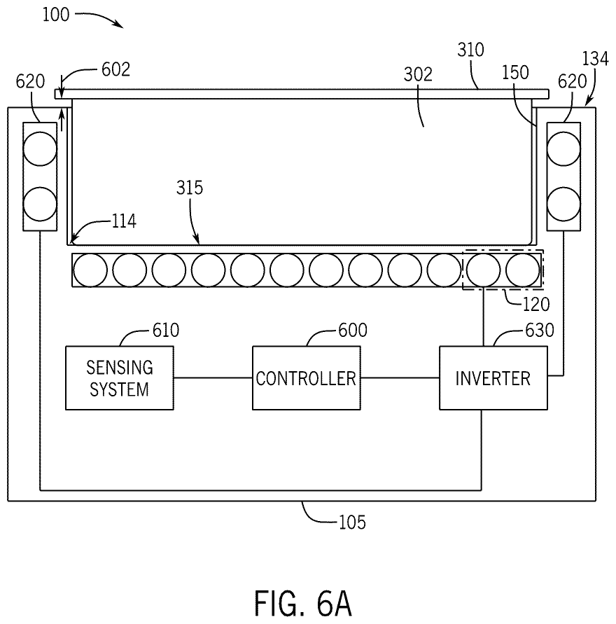

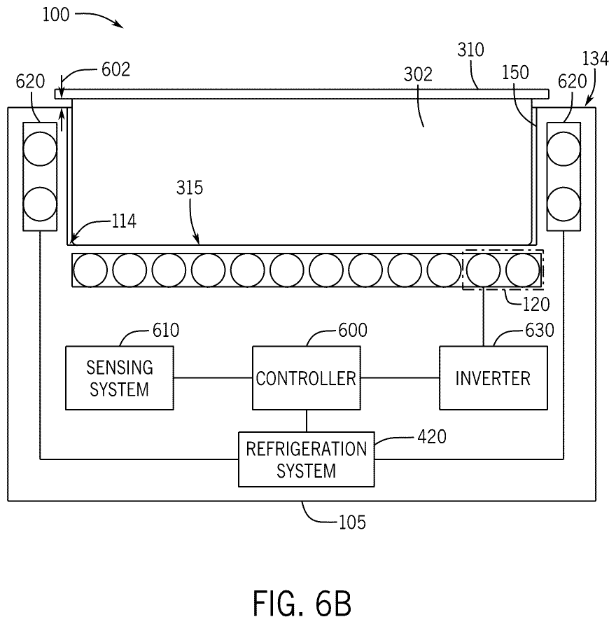

Referring to FIGS. 3A-3C, the changeable food vessels 300, 302 may comprise a rim 310 that extends outward from a main cooking surface 315 of the changeable food vessel 300, 302 at the upper extent of the changeable food vessel 300, 302. As discussed above, the changeable food vessel 300, 302, when inserted into the well 150, may rest on the top side 114 of the tray 110 (e.g., top side of the separator 124). For example, the surface of the food vessel opposite the main cooking surface 315 may rest directly on the separator 124. In some embodiments, the moveable tray 110 may be located at an appropriate depth within the well 150 to cause the rim 310 of the food vessel (the vessel resting on the separator 124) to rest on the top surface 134 of the well 150. In some embodiments, referring briefly to FIG. 6A, the moveable tray 110 may be located at an appropriate depth within the well 150 to cause the rim 310 of the food vessel (the vessel resting on the separator 124) to be spaced apart from the top surface 134 of the well 150 such that a gap 602 exists between the bottom of the rim 310 and the top surface 134 of the well 150, for example to allow human fingers to grip the rim 310 without needing an implement such as tongs to grab the food vessel.

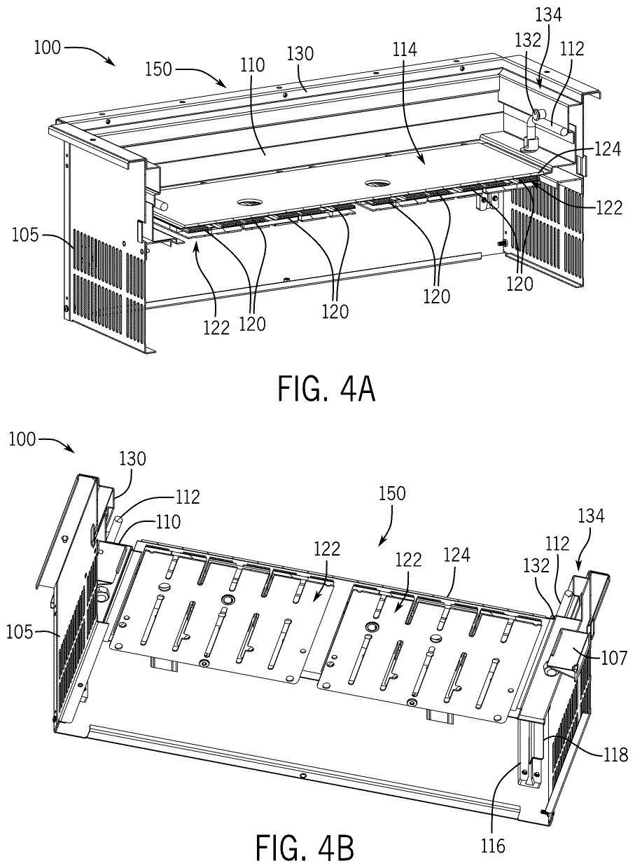

Referring to FIGS. 1, 4A, and 4B, the induction heating system 100 may comprise one or more induction coils 120 coupled to a bottom surface (opposite the top surface 114, and also referred to herein as a “bottom side”) of the separator 124 and moveable (e.g., to different depths) with the tray 110. The separator 124 may be made from a material that allows a magnetic field from the induction coil to pass through the top side 114, where the magnetic field may interact with one or more food vessels (not shown) to cause induction heating of the food vessel(s). In some embodiments, the separator may comprise a non-ferrous material, for example glass, ceramic, or the like.

In some embodiments, one or more induction coils 120 may be arranged in a coil assembly 122. The coil assembly 122 may be configured to provide a configurable source of induction heating to one or more food vessels resting on the top side 114 of the separator 124. For example, in some embodiments two coil assemblies 122 may be configurable to provide induction heating at one or more selectable locations proximate to the coil assemblies 122 (e.g., on the opposite side of the separator 124 from the coil assemblies 122), and/or provide no induction heating.

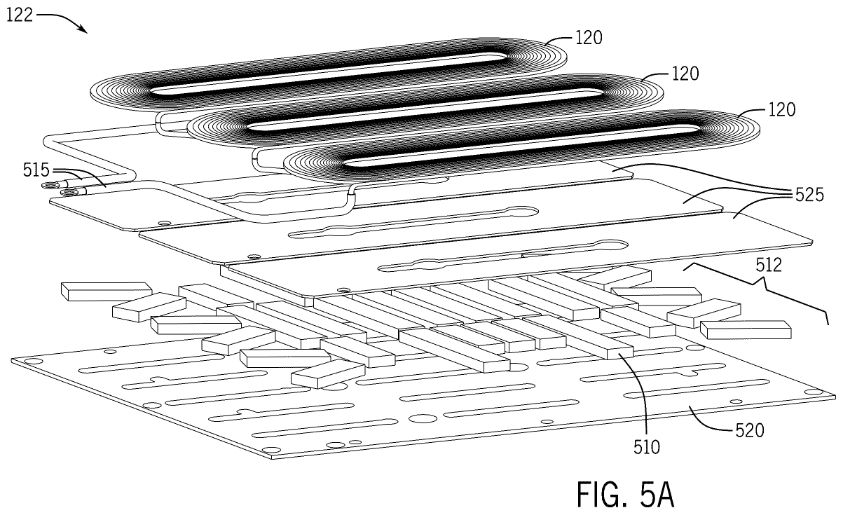

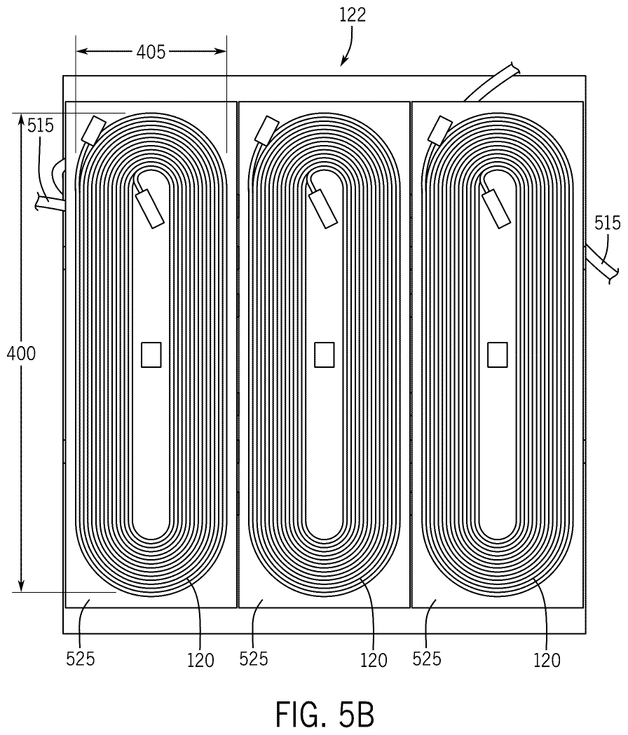

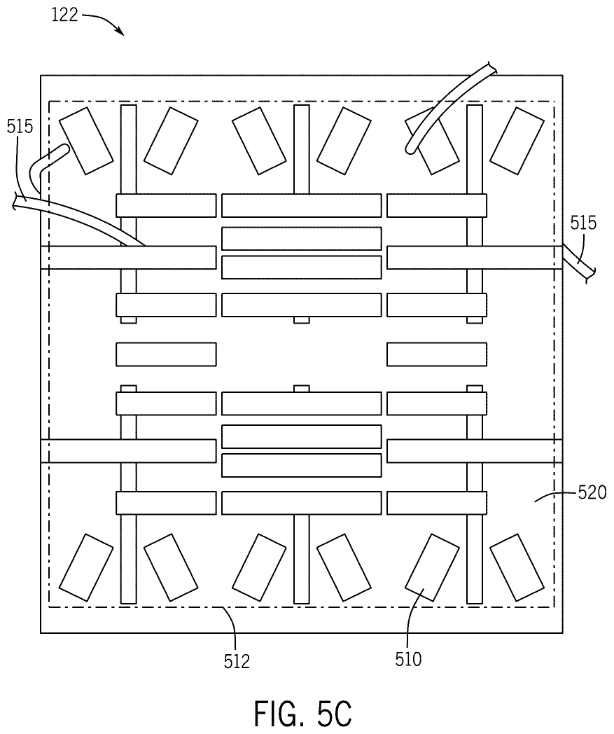

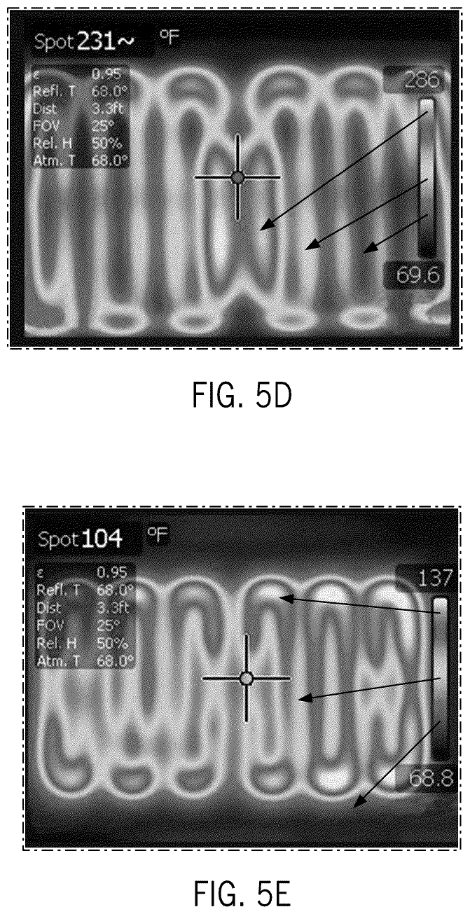

Referring to FIGS. 5A and 5B, the coil assembly 122 may comprise one or more induction coils 120 connected to electrical leads 515, wherein the electrical leads 515 can provide a source of alternating current to the induction coil 120, e.g., 120 VAC or 240 VAC. In some embodiments, each induction coil 120 of the coil assembly 122 may be attached to an upper backing plate 525 of the coil assembly 122. Referring to FIG. 5A, which shows the left and right induction coils 120 and respective upper backing plates 525 removed, in some embodiments the induction coil 120 and upper backing plate 525 may be attached over a ferrite arrangement 512 comprising a plurality of ferrite bars 510. The ferrite arrangement 512 may be attached to a lower backing plate 520, and the ferrite arrangement 512 and lower backing plate 520 may further make up the coil assembly 122. The upper backing plate 525 and/or lower backing plate 520 may be made from a metallic or non-metallic material. For example, the lower backing plate 520 may comprise aluminum, and the upper backing plates 525 may comprise mica.

In some embodiments, the ferrite bars 510 of the ferrite arrangement 512 may be positioned to spread the magnetic field evenly and provide a more even heating of the different food vessel configurations. For example, the positions of the ferrite bars 510 for one induction coil 120 may be designed to direct and modify the magnetic field produced by the induction coils 120 to produce an even heating pattern across a food vessel placed above the induction coils 120.

In some cases, when induction coils 120 are connected in series, electromagnetic interference can exist between the edges of the induction coils 120, where the magnetic field is enhanced or reduced according to the current direction flowing in the induction coil 120 wires. This can lead to unevenly distributed heat patterns in the food vessel above the induction coils 120, e.g., the power delivered to the food vessel is much lower if the magnetic field is cancelled or otherwise reduced in that area, for example due to the current flowing in opposite directions where two coils are adjacent. FIG. 5D shows an example of an unevenly distributed heat pattern caused by six induction coils (e.g., two adjacent coil assemblies 122 each having three induction coils 120 coupled in series).

Referring to FIG. 5C, in some embodiments, the pattern of the ferrite arrangement 512 is configured to achieve different ferrite densities at different areas of the coil assembly 122, and may be asymmetrically arranged among the various induction coils 120 of the coil assembly 122. In some embodiments, the overall ferrite density (i.e., the amount per area) of a coil assembly 122 is higher at the locations where a portion of an induction coil 120 has a current flow in the opposite direction from a portion of an adjacent induction coil to compensate for the magnetic field cancellation effect, and the overall ferrite density is lower toward the outside edges of the coil assembly 122 (the edges parallel to the major axes of the induction coils 120) to reduce the hot spot effect. The magnetic field density can accordingly be changed at predetermined locations about the induction coil(s) 120 and, referring to FIG. 5E, a more even heating of the food vessel can be achieved. FIG. 5E illustrates a thermal profile of a vessel according to the ferrite arrangements 512 of FIG. 5C, and shows reduced hot spot and more even heating over the entire vessel. The implementation of multiple smaller induction coils 120 allows for a more even heating of various sizes of food vessels because it provides more sources of magnetic field generation, and provides more locations for a ferrite arrangement to manipulate the generated magnetic field.

The number of induction coils 120 provided in the induction heating system, and the arrangement (e.g., pattern, spacing, etc.) of the induction coils 120, can be chosen to create an even distribution of heating for various sizes of changeable food vessels. The number of induction coils 120 may be chosen based on a predetermined set of changeable food vessel sizes, such that a set or subset of induction coils 120 are selectable for every predetermined configuration of changeable food vessel and such that none of the selected induction coils 120 overlap a rim 310 of a changeable food vessel in any of the predetermined food vessel configurations. In some embodiments, the induction coil 120 size and spacing may be chosen such that the outer perimeter of the selected group of induction coils 120 is approximately the same as the perimeter of the main cooking surface 315 of the food vessel for which the group of induction coils 120 was selected.

For example, if the induction heating system 100 is configured to accept only third-size pans 300 and full-size pans 302, the induction heating system 100 may have three induction coils 120 (single coil 120 sized and selectable for third-size pan 300, all coils 120 selectable for full-size pan 302). For further example, if the induction heating system 100 is configured to accept only half-size pans and full-size pans 302, the induction heating system 100 may have two induction coils 120 (single coil 120 sized and selectable for half-size pan, all coils 120 selectable for full-size pan 302). For further example, if the induction heating system 100 is configured to accept third-size pans 300, half-size pans, and full-size pans 203, the induction heating system 100 may have six induction coils (two adjacent coils 120 used for a third-size pan 300, three adjacent coils 120 used for a half-size pan, all coils 120 used for a full-size pan 302).

Referring to FIG. 5B, in some embodiments, the induction coils 120 may be wound in oblong shapes, for example ovals, to facilitate better coverage of multiple food vessel sizes. Each induction coil includes a length 400 and a width 405. In some embodiments, the length can be approximately 6 inches to 24 inches, and may be for example 8 inches to 12 inches. In some embodiments, the width can be 2 inches to 6 inches, and may be for example 2 inches to 4 inches, and in some embodiments does not exceed approximately 3.5 inches. In some embodiments, the coil assembly 122 may comprise three oblong induction coils 120, each with its own ferrite arrangement 512, the induction coils 120 and ferrite arrangements 512 being arranged on the upper backing plate 525 and lower backing plate 520 as previously described. Briefly referring to FIG. 1, the induction heating system 100 may comprise two such coil assemblies 122 for a total of six induction coils 120. In such embodiments, two adjacent induction coils 120 (e.g., the first two on the left, the first two on the right, or the middle two induction coils 120) may be used to heat a third-size pan 302 (thus a capacity of three third-size pans), three adjacent coils 120 (e.g., the first or second coil assembly 122) may be used to heat a half size pan (thus a capacity of two half-size pans), and all induction coils 120 may be used to heat a full-size pan.

In some embodiments, the induction coils 120 of each coil assembly 122 may be shaped and positioned with respect to the intended resting positions of the changeable food vessels such that the outer perimeter of the group of selected induction coils 120 lies within the rim 310 of the changeable food vessel being heated, preventing rim heating and providing more even heating of the main cooking surface 315. For example, if a third-size pan 300 is being heated, the shape and position of the two selected adjacent induction coils 120 may be configured such that the outer perimeter of the group of two induction coils 120 does not overlap the rim 310 of the third-size pan 300, when viewed from a direction perpendicular to the plane on which the induction coils 120 are wound, or, in other words, perpendicular to the upper backing plate 525, perpendicular to the top surface 114 of the separator 124 (referring to FIG. 4A), and perpendicular to the main cooking surface 315 (referring to FIGS. 3A-3C) of the changeable food vessel when resting in the well 150. At the same time, the shape and position of the three adjacent induction coils 120 selected for a half-size pan may be configured such that the outer perimeter of the group of three selected induction coils 120 does not overlap the rim 310 of the half-size pan. Further still, at the same time, the shape and position of the six induction coils 120 selected for a full-size pan 302 may be configured such that the outer perimeter of the group of six selected induction coils 120 does not overlap the rim 310 of the full-size pan 302.

In some embodiments, the winding direction and current flow of adjacent induction coils 120 may be set to create an even heating pattern for different size food vessels. In some embodiments, a plurality of coils can be connected in series arranged with the current flowing in the same or opposite directions to increase or decrease the intensity of the resulting magnetic field, to provide an even heating pattern to the main cooking surface 315 of one or more changeable food vessels. In some embodiments, all three induction coils 120 of a coil assembly 122 may be connected in series and arranged in the same winding direction. The portion of an induction coil 120 adjacent to another induction coil 120 (in this arrangement) will have current flowing in the opposite direction to the adjacent induction coil 120 at that location, which will cause the magnetic field to cancel and can lead to a cold spot. In some such embodiments, the ferrite arrangement 512 may have an increased density in such locations to compensate for the cold spot effect. The ferrite arrangement 512 in combination with the connection arrangement of the induction coils 120 (e.g., in series with current flowing in the same or opposite directions) may be configured to provide an even heating pattern to the main cooking surface 315 of one or more changeable food vessels resting in the well 150.

In some embodiments, the heating induction system 100 may be configured to accommodate food vessels of a size that have a rim 315 that will overlap one or more induction coils 120. The coil assemblies 122 may be configured (i.e., induction coils 120 sized and arranged) such that for vessels having a rim 315 that overlaps the induction coils 120, the rim 315 will overlap at or near a location where two induction coils 120 are adjacent. Excessive rim heating of such vessels will be prevented because of the cold spot effect at the location of adjacency, as discussed above, the more even distribution of the generated magnetic field due to the ferrite arrangement 122, and because the reduced number of turns of each induction coil 120 (compared to a single larger coil to provide heating over the same area as the multiple smaller induction coils 120) leads to a reduced magnetic field strength at such a location. For example, in some embodiments, each induction coil 120 may have about 8 to 20 or less turns, for example 11 or 12 turns each, relating to a width of 3.5 inches or less in some embodiments, whereas a single larger coil used to heat the same area may require at least 25 to 45 turns, relating to a width larger than 3.5 inches, such as 5 inches or larger. The multiple smaller induction coils 120 (compared to larger coils) of the induction heating system 100 will cause a more evenly distributed magnetic field across the area of the well 150. To the contrary, a larger coil will concentrate the larger magnetic field around the coil such that excessive heating can occur at a food vessel rim located above the larger coil. There is less rim heating from the magnetic field of the coil under the rim 315, due to the width of each individual coil 120 comprising the coil assembly 122 is significantly less than the individual width of one large coil traversing the full width of the rim of a food vessel when a particular pan size cuts across the windings of the coil. In addition, the use of multiple smaller size coils can help to allow for each coil 120 or coil assembly 122 to provide greater coverage of the bottom of different size food vessels. Thus systems using a larger coil are limited to a single size of food vessel designed for the particular larger coil, and cannot flexibly accommodate multiple food vessel sizes.

In some embodiments, the ferrite arrangement 512 in combination with the arrangement of the induction coils 120 may be configured to provide more even heating while not creating an excessive hot spot (e.g., too hot for skin to touch) in the rim 315 of food vessels of a size that have a rim that will overlap the induction coils 120. For example, as discussed above, adjacent induction coils 120 arranged in the same winding direction and connected in series can have a cold spot effect caused by current flowing in opposite direction at the location where the induction coils 120 are adjacent, and the ferrite arrangement 512 can be configured to have an increased density at such locations to provide an increased uniformity in the heating pattern, but not to the extent that causes excessive heating of such rims. In other words, the ferrite arrangement 512 can be configured to increase the consistency of heating without overheating a rim 315 that is located above the location where two induction coils 120 are adjacent.

Referring to FIGS. 6A and 6B, in some embodiments the induction heating system 100 may comprise one or more coils positioned to provide heating or cooling to the side walls (e.g., perpendicular to the main cooking surface 315) of the food vessel resting in the well 150 so as to facilitate a hot or cold well. Such coils are referred to herein as side coils 620. In some embodiments, the side coils 620 may be positioned on the side walls of the well 150 (e.g., attached to a side wall of the tray 110 on the surface opposite the well 150). The side coils 620 may cover the perimeter of the well 150 side walls (e.g., surrounding the well 150). In some embodiments, the side coils 620 may be separate from the induction coils 120, for example when the side coils comprise a cooling coil such as a refrigerant coil, and/or as separate induction heating coils, and are coupled to a refrigeration system 420. In some embodiments, the side coils 620 may comprise a portion of the induction coils 120. For example, the induction coils 120 may be wound to cover the main cooking surface 315 of the food vessel as well as extending up the side walls of the tray 110. The side walls of the tray 110 may be constructed with a non-ferrous material, for example the same material as the separator 124, and may move with the tray 110. The side coils 620 may generate a magnetic field to heat the side of a food vessel. In some embodiments, a power distribution may be chosen to provide even and proper heating of the food vessel. For example the side coils 620 may comprise fewer turns than the induction coils 120 to achieve a certain percent of power distribution, such as 20% side coils 620 and 80% induction coils 120. In another example, the side coils 620 may be refrigeration coils connected to a refrigeration system 420, such as a compressor, and the side walls may be cooled separately from the main cooking surface 315 being heated in different time periods.

Still referring to FIG. 6A, the induction heating system 100 may comprise a controller 600 communicatively coupled with a sensing system 610 and one or more power inverters 630 (also referred to herein as an inverter) and/or one or more refrigeration systems 420. The inverter(s) 630 may be electrically coupled with the one or more induction coils 120 and/or side coils 620, for example by the electrical leads 515, and may provide a source of alternating current. The inverter 630 may be configured to convert low-frequency AC power (e.g., mains electricity) to higher frequency for AC power for use by the induction coils 120 to perform induction heating. In some embodiments, the inverter 630 may comprise a resonant tank circuit consisting of a capacitor and an inductor, and the inductance of the tank circuit may be the inductance of the induction coil(s) 120. The refrigeration system 420 may comprise one or more compressors or other cooling methods.

In some embodiments, the induction heating system 100 comprises a first inverter 630 coupled to power a first set of induction coils 120 (e.g., a first coil assembly 122, for example having three induction coils 120) and a second inverter 630 coupled to power a second set of induction coils 120 (e.g., a second coil assembly 122, for example having three induction coils 120). The controller 600 may comprise a human-machine interface (HMI) device configured to receive information regarding a user's input (e.g., temperature, food vessel arrangement, or the like). The controller 600 may convert the user input to a control command which it may then communicate to the one or more inverters 630.

In some embodiments, the inverter 630 may be configured, upon receiving an enable command from the controller 600, to send pulse signals to detect if a proper vessel is located on top of the one or more connected induction coils 120. The controller can receive the free resonant frequency and pulse count of the free resonant. If the frequency and pulse count are within a predefined range, then the controller determines that a vessel is located above one or more connected induction coils 120 and is of a compatible material. Upon such a determination, the inverter 630 may enter a working mode to provide current to the one or more connected induction coils 120 to generate the magnetic field for heating the vessel. If the vessel is placed incorrectly, not present, not big enough, of a non-compatible material, or the like, the inverter 630 will not enter the working mode to protect itself from damage.

In some embodiments, all induction coils 120 connected to an inverter 630 may be powered or unpowered together. In some embodiments, induction coils 120 connected to an inverter 630 may be individually selectable to receive power, where one or more induction coils 120 may be powered while one or more other induction coils 120 connected to the same inverter 630 may be unpowered. In the case of all induction coils 120 being powered or unpowered together, if the connected inverter 630 enters a working mode, all induction coils 120 will receive the same current flow. In this case, and for a vessel that is smaller in width than the collection of induction coils 120 coupled to the inverter 630 (e.g., a third size pan covers two induction coils 120 and all three induction coils 120 are powered), the powered and covered induction coil(s) 120 provide enough energy to sufficiently heat the vessel, while the powered but not-covered induction coil(s) 120 act as a dummy load to generate some heat loss and the energy loss in the not-covered induction coil(s) 120 is very limited due to its low impedance.

The controller 600 may be configured to send and/or receive information (e.g., including instructions, data, values, signals, or the like) to/from the various components of the induction heating system 100. The controller 600 may comprise processing circuitry (not shown), for example, a processor, DSP, CPU, APU, GPU, microcontroller, application-specific integrated circuit, programmable gate array, and the like, any other digital and/or analog components, as well as combinations of the foregoing (whether distributed, networked, locally connected, or the like), and may further comprise inputs and outputs for receiving and providing control instructions, control signals, drive signals, power signals, sensor signals (e.g., thermal sensor output), digital signals, analog signals, and the like. All such computing devices and environments are intended to fall within the meaning of the term “processor,” “processing device,” or “processing circuitry” as used herein unless a different meaning is explicitly provided or otherwise clear from the context. In some examples, the controller 600 may comprise one or more such processor devices.

The controller 600 may comprise processing circuitry configured to execute operating routine(s) stored in a memory (not shown). The controller 600 may directly include the memory (e.g., local memory) or may be otherwise communicatively coupled to the memory (e.g., a remote server). The memory may include any suitable volatile memory, non-volatile memory, storage, any other suitable type of storage medium, or any suitable combination thereof. For example, the memory may include RAM, ROM, EEPROM, one or more flash drives, one or more hard disks, one or more solid state drives, one or more optical drives, etc. In some embodiments, the memory (e.g., a media) may have encoded thereon a computer program (e.g., operating routine) for controlling operation of the controller 600, the inverter 630, the sensor system 610, a human interface, and the like. In some embodiments, the various components of the induction heating system 100 may be implemented entirely as software (e.g., operating routine), entirely as hardware, or any suitable combination thereof. In some embodiments, the operating routine(s) may comprise firmware. The present disclosure contemplates methods, systems, and program products on any machine-readable media for accomplishing various operations.

In some embodiments, the sensing system 610 comprises a plurality of thermal sensors placed about the well 150. In some embodiments, the thermal sensors may comprise thermistors. In some embodiments, one or more thermal sensors may be physically coupled to the bottom side of the tray 110 such that they can sense a temperature of the separator 124 adjacent to the thermal sensor. The thermal sensors may be directly or indirectly coupled with the bottom side of the separator 124. Thus, the tray 110 may provide support for the induction coils 120 and thermal sensors.

When the induction heating system 100 is active and heating a food vessel in the well 150, the food vessel will transfer some heat to the separator 124 at the location where the food vessel is resting on the separator 124. The separator 124 may be made from a thermally conductive material. The thermal sensor(s) may therefore indirectly measure the temperature of the food vessel in the location proximate to each thermal sensor by measuring the temperature of the separator 124 at the location where each thermal sensor is located. The thermal sensor(s) may also measure the temperature of the separator 124 when there is no food vessel directly above the respective thermal sensor, and/or when the induction heating system 100 is not heating a food vessel. Likewise, in some embodiments, thermal sensors may be placed on the sides of the tray 110, for example in embodiments having side coils 620. In some embodiments, the controller 600 may adjust the power to the side coils 620 and induction coils 120 to optimize the heating pattern.

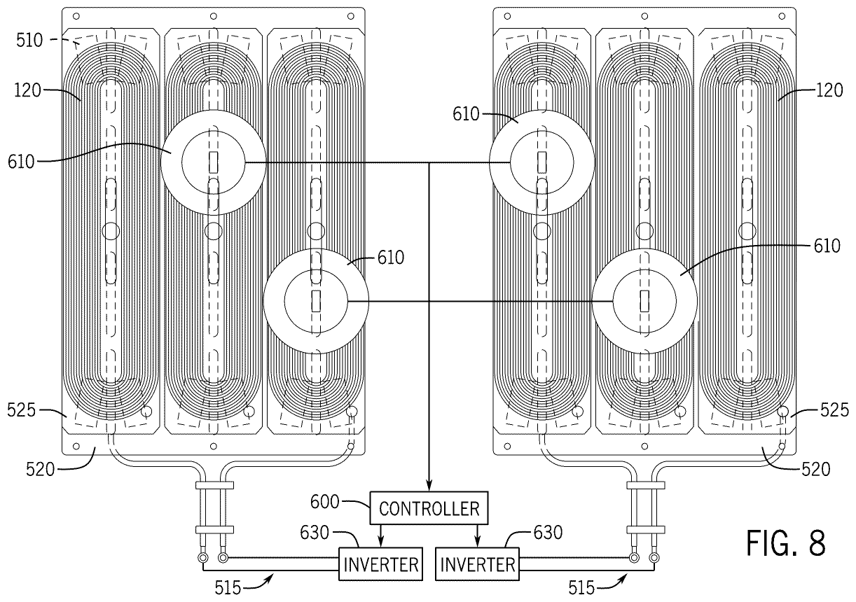

Referring briefly to FIG. 8, in some embodiments, multiple thermal sensors (e.g., thermistors) may be placed below the separator 124 and above the induction coils 120. For example, each of the multiple thermal sensors may be placed above one of the induction coils 120. In some embodiments, one or more of the thermal sensors may be offset from the centerline of the coil assembly 122 (the centerline running perpendicular to the major axes of the induction coils 120 of the coil assembly 122) by a predetermined distance, e.g., by about two inches, to facilitate detecting temperature when using different food vessel combinations, e.g., fourth-size, sixth-size, or half-size long pans. In one embodiment, four thermal sensors may be placed above six induction coils 120, one thermal placed above each of the induction coils 120 except for the exterior induction coils 20, and offset from the centerline in an alternating pattern (e.g., each thermal sensor is offset in the opposite direction from the centerline as compared to its neighbors). In some embodiments, each coil assembly 122 may comprise multiple thermal sensors (e.g., thermistors), at least one of which is offset from the centerline of the coil assembly 122.

In some embodiments, the controller 600 may receive one or more temperature measurements from each of the one or more thermal sensors. The controller 600 may evaluate the one or more temperature measurements to determine (indirectly) a temperature of the one or more food vessels resting on the separator 124. Based on the determined temperature, the controller may regulate the temperature of the one or more food vessels by appropriately controlling power to one or more induction coils 120, for example by controlling the one or more inverters 630. For example, if the controller 600 determines that a food vessel has not reach a chosen temperature setpoint (e.g., temperature setting), the controller 600 may cause the induction coils 120 below the respective food vessel to receive additional power.

In some embodiments, the sensing system 610 may comprise multiple infrared thermal sensors mounted on the inside of the food well 150 and/or external to the food well 150 and configured to detect infrared radiation from one or more food vessel(s) and thereby indirectly detecting the temperature of food within the food vessel(s). In some embodiments, the sensing system 610 may comprise an infrared thermal sensor placed in or on the cover of a food vessel, with the measurements from the infrared thermal sensor sent wirelessly (or by wire) to the controller 600. The controller 600 may receive measurements from one or more of these infrared thermal sensors and may determine a temperature of the food vessel(s) or food within the food vessel(s), and may accordingly regulate the temperature of the food product and/or food vessel to the desired temperature (e.g., according to a setpoint). In some embodiments, the thermal sensor may comprise a food probe configured to be placed within the food vessel and contacting the food product. Advantageously, with the use of multiple thermal sensors placed such that at least one thermal sensor will be located proximate to a food vessel regardless of which predetermined configuration of food vessels is present, the controller 600 can identify a large variety of different food vessel sizes and regulate the temperature of the food vessel(s) to the same or per-vessel temperature targets.

In some embodiments, the controller 600 may determine that no food vessel is present at a certain location in the well 150, and/or that a food vessel exists at a certain location in the well 150. In an exemplary embodiment, the controller 600 may cause all induction coils 120 to receive power (e.g., a lower amount of power) and may observe the plurality of temperature measurements from the thermal sensors. Then, based on which thermal sensors measure an increase in temperature (e.g., above a predetermined threshold) and/or which thermal sensors do not measure such an increase in temperature, the controller 600 may determine a food vessel to be present at the location(s) of the thermal sensors that measured the increase in temperature and/or not present at location(s) of the thermal sensors that did not measure such an increase in temperature. In some embodiments, if the thermal sensor indicates that the temperature at a specific location is increasing faster than a normal (e.g., predetermined) slew rate, the controller 600 may determine that the food vessel at that location is running out of food and may adjust power to the induction coils 120 accordingly. The controller 600 may then select all induction coils 120 directly below the identified food vessel(s) to receive power to provide heating to the identified food vessel(s), and may prevent the non-selected induction coils 120 (those not directly below the identified food vessel(s)) from receiving power.

To heat the food vessels efficiently, the food vessel(s) should be within a certain distance (measured perpendicular to the plane on which the coils are wound) of the induction coils 120. In some embodiments, the induction coils 120 are placed within one-half inch from the resting location of the food vessel (e.g., the top side 114 of the separator 124) to provide an efficient coupling and heat energy transfer. In some embodiments, if the movable tray 110 is positioned within the well 150 for use with a deeper food vessel (e.g. a 4-inch food pan), but a shallower food vessel is placed in the well 150 (e.g., a 2½ inch food pan), the rim 310 of the food vessel would sit on the top surface 134 of the well 150 and the food vessel would not rest on the top side 114 of the separator 124. In such a case, the food vessel may be too far from the induction coil(s) 120 to receive appropriate (e.g., efficient, sufficiently localized, etc.) heating. The controller 600 may determine, based on the temperature measurements, that a food vessel is too far away from the separator 124 (or, respectively, the induction coils 120) and may determine to not provide power to the respective induction coils 120 (or to all of the inductive coils 120) or to otherwise turn off or disable part of the induction heating system 100.

In some embodiments, the sensing system 610 may comprise one or more current sensors coupled the one or more induction coils 120 to measure a current flowing through the respective induction coils 120. In some embodiments, the sensing system 610 may comprise one or more magnetic field sensors placed about the one or more induction coils 120 to measure a magnetic flux generated by the respective induction coils 120. The current sensors and/or magnetic field sensors may be coupled with the controller 600. The controller 600 may determine, based on the current and/or magnetic field measurements, whether a food vessel is present at the respective location and/or whether a food vessel is located too far away from the separator 124. In some embodiments, control of the inverter 630 is closed loop control. If a food vessel is moving away from the induction coil(s) 120, the current in the induction coil(s) 120 will increase to keep the required heating energy. However, due to the lack of a food vessel, the increasing coil current may not result in an increase in the input power measurement. The controller 600 can determine, based on the combination of the coil current and the input power measurement, if the vessel has been moved away from the induction coil(s) 120. As discussed above, if the controller 600 determines that the food vessel is not present or otherwise too far away from the separator 124, the controller 600 may accordingly determine to turn off the respective induction coils 120.

In some embodiments, for example as referenced above, the induction heating system 100 may receive a temperature setpoint for all food vessels and/or individual food vessels. The temperature setpoint may be input via an interface device (not shown) of the induction heating system 100. The interface device may comprise a human interface (e.g., dial, buttons, keypad, mobile device interface, or the like) configured to allow a user to input a temperature setpoint, food vessel size(s), food vessel configuration, and so on. In some embodiments, the interface device may be a remote interface, for example a software interface operating on a computer device networked with the induction heating system 100 (e.g., via local network, cloud computing environment, short-range wireless communication, infrared communication, or the like).

In some embodiments, the temperature setpoint may comprise a setpoint for one or more inverters 630 and/or one or more food vessels. In some embodiments, the temperature setpoint may be the same setpoint for each of the inverters 630 and/or separate setpoints for each inverter 630. Likewise, in some embodiments, the temperature setpoint may be the same setpoint for each of the food vessel(s) for which the induction heating system 100 is configured and/or separate setpoints for each of the respective food vessel(s). For example, in some embodiments, the induction heating system 100 may be configured to allow for a user to input the size of the pan being heated (e.g., third-size, half-size, full-size, depth, etc.) and/or depth and the controller 600 may control the inverter(s) 630 to provide the appropriate output power to maintain the desired temperatures. In some embodiments, the induction heating system 100 may lack the sensing system 610 (e.g., may lack thermal sensors) and may instead control the temperature(s) of the one or more food vessels through a predetermined algorithm based on the size and/or position and/or quantity of the food pans (e.g., as input by a user). In some embodiment having thermal sensors, the inverter 630 will regulate the power to the induction coils 120 to hold the food vessel temperature at the user-specified setpoint(s). In other embodiments, some of which may not include any system or method to determine the temperature of the food vessel, the inverter 630 may work under a power control mode in which it will deliver a constant power based on the user-specified setpoint(s).

In some implementations, devices or systems disclosed herein can be utilized or configured for operation using methods embodying aspects of the invention. Correspondingly, description herein of particular features, capabilities, or intended purposes of a device or system is generally intended to inherently include disclosure of a method of using such features for the intended purposes, a method implementing such capabilities, and a method of configuring disclosed (or otherwise known) components to support these purposes or capabilities. Similarly, unless otherwise indicated or limited, discussion herein of any method of manufacturing or using a particular device or system, including configuring the device or system for operation, is intended to inherently include disclosure, as embodiments of the invention, of the utilized features and implemented capabilities of such device or system.

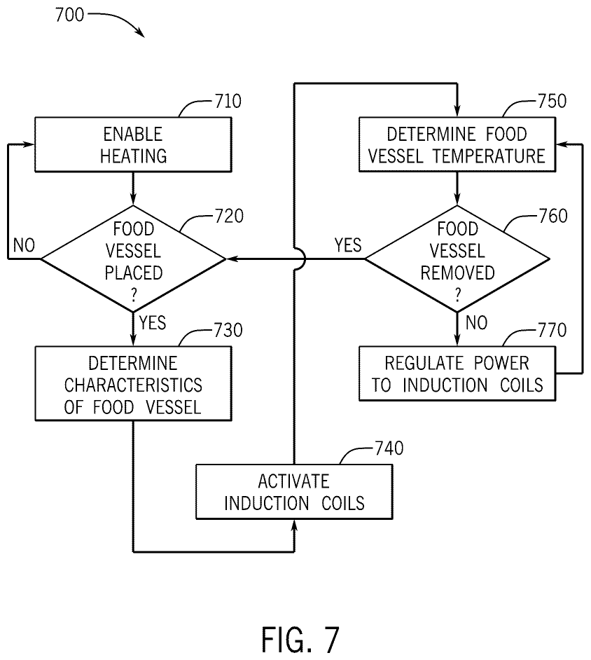

Correspondingly, some embodiments of the present disclosure can include a method for providing induction heating to one or more changeable food vessels. Referring to FIG. 7, a non-limiting example of method for induction heating 700 is illustrated. In some embodiments, the induction heating method 700 may be implemented in the controller 600, for example, as operating routines stored in memory (e.g., as software). The induction heating method 700 may comprise enabling food vessel heating 710, determining whether a food vessel has been placed in the induction heating system 100, determining a characteristic of the food vessel(s) 730, activating induction coil(s) 120 to provide heating 740, determining a temperature of the food vessel(s) 750, determining if a food vessel has been removed 760, and regulating the power to the induction coil(s) 120 based on the determined temperature 770.

At step 710, the induction heating system 100 may be enabled. In some embodiments, enabling the induction heating system 100 may comprise turning on the induction heating system 100. In some embodiments, enabling the induction heating system 100 may comprise the controller 600 receiving one or more temperature setpoints and/or food vessel configuration information. In some embodiments, enabling the induction heating system 100 may comprise the controller 600 receiving an instruction to begin providing heat to food vessels.

At step 720, the controller 600 may determine whether a food vessel has been placed in the well 150. For example, as described above, the controller 600 may enable the inverters 630 to provide an amount of power (e.g., a reduced amount of power) to the induction coils 120 and may determine whether a food vessel is placed in the well 150 according to measurements subsequently received from the sensing system 610 (e.g., via thermal, current, and/or magnetic sensors). If, at step 720, the controller 600 determines that no food vessel is present in the well 150, the controller 600 may return to step 710 (e.g., disabling the inverters 630) or otherwise continue to check 720 (e.g., at regular intervals) for the presence of a food vessel.

If, at step 720, the controller 600 determines that a food vessel is present, then at step 730 the controller 600 may determine a characteristic of the present food vessel(s). In some embodiments, the determined characteristic may comprise the number and/or size of the food vessels (e.g., half-size, third-size, etc.), the depth of the food vessel(s), and/or the location of the food vessel(s) within the well 150. In some embodiments, at step 730, the controller 600 may determine the characteristic of the food vessel(s) according to temperature measurements from thermal sensors as described above. In some embodiments, the controller 600 may have accessible (e.g., in memory) the predetermined locations of the induction coils 120 and the thermal sensors about the well 150. The controller 600 may determine the location and/or size of the food vessel(s) based on the locations of the thermal sensors that provide an appropriate temperature measurement (e.g., above a predetermined threshold). In some embodiments, steps 720 and 730 may be accomplished as part of the same determination by the controller 600.

At step 740, the controller 600 may activate the appropriate induction coils 120 to provide heat to the food vessels as identified from step 730. The controller 600 may, at step 740, select appropriate induction coils 120 to provide heat. In some embodiments, the controller 600 may select only those induction coils that are directly below the identified food vessel(s), for example based on the determined location and/or size from step 730 and according to the predetermined locations of the induction coils 120 (e.g., as stored in memory). The controller 600 may, after selecting the induction coils 120, activate the selected induction coils 120 (e.g., only those that are directly below the identified food vessel(s)). As described above, activating the induction coils 120 may comprise any suitable system or method for selectively powering the induction coils 120. In some embodiments, activating the induction coils 120 may comprise enabling an inverter 630 coupled with a coil assembly 122 located below the identified food vessel(s).

At step 750, the controller 600 may determine a temperature of one or more identified food vessels according to the relevant temperature measurements received from the sensing system 610, and at step 770 the controller 600 may accordingly regulate power to one or more induction coils 120 based on the determined temperature from step 750, for example according to a received temperature setpoint. In some embodiments, the controller 600 may regulate a first induction coil 120 (e.g., corresponding to a first food vessel) differently from a second induction coil 120 (e.g., corresponding to a second food vessel), such that each respective food vessel is maintained at an appropriate temperature.

In some embodiments, prior to step 770, the controller 600 at step 760 may determine whether a food vessel has been removed or the food vessel configuration has otherwise changed. The controller 600 may make this determination based on the received temperature measurements from step 750. If, at step 760, the controller 600 determines that the food vessel configuration has not changed, the controller 600 may continue to step 770 to regulate to power to the induction coils 120 based on the received temperature measurements. If, at step 760, the controller 600 determines that the food vessel configuration has changed, then it may return to step 720 to determine whether a food vessel exists in the well 150, and/or may go to step 730 to determine the new characteristics of any food vessel present in the well 150.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Systems and methods according to the present disclosure have several advantages. For example, in some embodiments, the use of multiple induction coils (e.g., six induction coils 120 with each three coils powered by a separate inverter 630) minimizes the edge heating of the food pans and provides even heating of the different pans that can be placed in the food well. Further, each inverter 630 and/or induction coils 120 can be separately controlled to allow for different control temperatures within the food well. Different control temperatures can be applied to one food pan or more than one food pan. As an additional advantage, oblong (e.g., oval-shape) induction coils 120 can extend the heating area further toward the rims 310 of the food vessels instead of concentrating heating in the center of the food vessels. The disclosed induction coil 120 configuration makes it possible to fit a variety of food vessel sizes and configurations within the same well 150, such as third-size, half-size and full-size, without heating the rims 310 of in any vessel configuration. For example, when heating third-size pans, the edge of the pan will sit in-between two induction coils 120 (one which will be used to heat the pan and one which will not be used) which can significantly reduce the heating effect on the rim 310 and can keep the pan edge safe for users (e.g., prevents skin burns).

It is important to note that the construction and arrangement of the induction heating system 100 as shown in the various exemplary embodiments is illustrative only. It will be appreciated by those skilled in the art that while the disclosed subject matter has been described above in connection with particular embodiments and examples, the present disclosure and the claims of the present disclosure are not necessarily so limited, and that numerous other embodiments, process flows and step ordering, examples, uses, modifications and departures from the embodiments, examples and uses are intended to be encompassed by the claims attached hereto. It will be appreciated that there are additional ways to provide heating to food vessels other than induction coils which may be arranged as described herein to improve heating to changeable food vessels while reducing heating of the rims of such food vessels. It will also be appreciated that the systems and methods described herein may be altered to provide cooling (instead of heating) to one or more changeable food vessels. The entire disclosure of each patent and publication cited herein is hereby incorporated by reference, as if each such patent or publication were individually incorporated by reference herein.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, is intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, communicative, electrical, or fluidic. Communicative coupling may comprise electrical coupling (e.g., electrical signals in analog or digital format, control signals, and the like).

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure. It will be generally understood that a “top” may comprise a surface of an object that is opposite to a “bottom” surface of an object, unless otherwise indicated.

Various features and advantages of the various aspects presented in the present disclosure are set forth in the following claims.

We claim:

1. An induction heating system for a first food vessel of a first size and a second food vessel of a second size, comprising:
a base defining a well configured to separately receive the first food vessel and the second food vessel;
a tray configured to attach within the well;
a plurality of coil assemblies mounted to a bottom side of the tray, wherein:
each coil assembly comprises a plurality of induction coils electrically coupled in series, wherein for each coil assembly:
each of the plurality of induction coils defines an oblong shape having a length and a width;
each of the plurality of induction coils is arranged adjacent to at least one other of the plurality of induction coils along a longest side of the induction coil; and
the plurality of induction coils are electrically coupled with an inverter of the induction heating system;
a sensing system configured to indirectly measure a temperature of the first food vessel when the first food vessel is resting in the well and the second food vessel when the second food vessel is resting in the well; and
a controller communicatively coupled with the sensing system and the inverter, wherein the controller is configured to:
receive the temperature measurement from the sensing system; and
control the inverter according to the measurement.

2. The system of claim 1, wherein each of the plurality of coil assemblies comprise a ferrite arrangement arranged about the plurality of induction coils, wherein the ferrite arrangement has an increased density proximate to where two of the plurality of induction coils are adjacent and a decreased density at an outer side of the coil assembly.

3. The system of claim 1, further comprising two coil assemblies, wherein each coil assembly comprises three induction coils.

4. The system of claim 1, wherein each of the plurality of coil assemblies is electrically coupled with a separate inverter.

5. The system of claim 1, wherein the tray is a moveable tray configured to attach within the well, wherein the well is configured to attach with the moveable tray at a first tray depth and at a second tray depth, and wherein:
the first tray depth is in accordance with a first food vessel depth and the second tray depth is in accordance with a second food vessel depth, wherein the first food vessel depth is different than the second food vessel depth.

6. The system of claim 5, wherein:
when the moveable tray is attached at the first tray depth, the distance between a top surface of the well and a top side of the moveable tray is less than the first food vessel depth; and
when the moveable tray is attached at the second tray depth, the distance between the top surface of the well and the top side of the moveable tray is less than the second food vessel depth.

7. The system of claim 6, wherein:
when the moveable tray is attached at the first tray depth and the first food vessel is resting in the well, the rim of the first food vessel is spaced apart from the top surface of the well; and
when the moveable tray is attached at the second tray depth and the second food vessel is resting in the well, the rim of the second food vessel is spaced apart from the top surface of the well.

8. The system of claim 4, wherein:
the sensing system comprises a plurality of thermal sensors arranged about each of the plurality of coil assemblies;
the temperature measurement comprises a plurality of temperature measurements, one from each of the plurality of thermal sensors; and
the controller is configured to:
determine a location of the first food vessel or the second food vessel based on the plurality of temperature measurements; and
select, from the plurality of coil assemblies, the one or more coil assemblies located directly below the determined location of the first food vessel or the second food vessel; and
control the inverter electrically coupled with each of the one or more selected coil assemblies to provide power to the plurality of induction coils of the selected coil assembly.

9. The system of claim 8, wherein the plurality of thermal sensors comprise a plurality of thermistors coupled to the bottom side of the moveable tray.

10. The system of claim 8, wherein the controller is configured to:
receive a temperature setting; and
control the inverter electrically coupled with each of the one or more selected coil assemblies to provide power to the plurality of induction coils of the selected coil assembly according to the temperature setting and the plurality of temperature measurements.

11. The system of claim 1, wherein the tray comprises a non-ferrous material.

12. A method for heating a changeable food vessel resting in a food well, wherein the changeable food vessel can be a first food vessel of a first size or a second food vessel of a second size, and wherein a plurality of coil assemblies each having a plurality of induction coils are attached to the bottom side of the food well, the method comprising:
determining, by a controller, a location and a size of the changeable food vessel in the well;
selecting, by the controller, one or more of the plurality of coil assemblies to heat the changeable food vessel;
receiving, by the controller and from a plurality of thermal sensors coupled to the food well, a plurality of temperature measurements;
receiving, by the controller, a temperature setpoint for the changeable food vessel; and
controlling, by the controller, a power to the selected coil assemblies according to the received temperature measurements and the received temperature setpoint.

13. The method of claim 12, wherein each coil assembly comprises an inverter electrically coupled to the induction coils, and wherein controlling the power to the selected coil assembly comprises controlling the inverter of the selected coil assembly.

14. The method of claim 12, wherein the one or more coil assemblies are selected according to the determined location and the determined size of the changeable food vessel.

15. The method of claim 14, wherein selecting the one or more coil assemblies comprises selecting only the coil assemblies from the plurality of coil assemblies that are located directly below the changeable food vessel.

16. The method of claim 12, wherein determining the location and the size of the changeable food vessel comprises determining the location and the size of the changeable food vessel based on the received plurality of temperature measurements.

17. The method of claim 16, wherein determining the location and the size based on the received plurality of temperature measurements comprises determining the location and the size of the changeable food vessel according to a location of the one or more thermal sensors from which a temperature measurement above a predetermined threshold was received.

18. The method of claim 12, wherein:
determining the location and the size of the changeable food vessel comprises determining a location of the one or more thermal sensors from which a temperature measurement above a predetermined threshold was received; and
selecting the one or more coil assemblies comprises selecting only the coil assemblies from the plurality of coil assemblies that are directly below the changeable food vessel based on the determined location and size of the changeable food vessel.

19. An induction heating system for a changeable food vessel, wherein the changeable food vessel can be a first food vessel of a first predetermined width or a second food vessel of a second predetermined width, wherein the second width is larger than the first width and wherein the second width is less than full-width, comprising:
a well configured to separately receive the first food vessel and the second food vessel;
a plurality of induction coils mounted to a bottom side of the well, wherein:
a perimeter of a first set of the plurality of induction coils, located directly below a first well location where the well is configured to receive the first food vessel, does not overlap the rim of the first food vessel; and
a perimeter of a second set of the plurality of induction coils, the second set comprising the first set and located directly below a second well location where the well is configured to receive the second food vessel, does not overlap the rim of the second food vessel;
a plurality of thermal sensors arranged about the well, wherein the thermal sensor arrangement is configured to indirectly measure a temperature of the changeable food vessel; and
a controller communicatively coupled with the plurality of thermal sensors and the plurality of induction coils, wherein the controller is configured to:
receive a plurality of temperature measurements from the plurality of thermal sensors;
determine the well location and the width of the changeable food vessel;
select one of the first set of induction coils or the second set of induction coils based on the determined well location and width; and
control power to the selected set of induction coils according to the plurality of temperature measurements and the received temperature setting.

20. The system of claim 19, wherein the well location and width of the changeable food vessel is determined according to the received temp measurements.

21. The system of claim 1, wherein the width of each of the plurality of coils is at or less than 3.5 inches and each of the plurality of coils has 20 or less turns.
